(19) United States
(12) Patent Application Publication
(10) Pub. No.: US 2007/0251780 A1
(43) Pub. Date: Nov. 1, 2007

(54) Frame Integrated Bicycle Brake System

(76) Inventor: John Thomas Lyons, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/735,277

(22) Filed: Apr. 13, 2007

Related U.S. Application Data
(60) Provisional application No. 60/744,834, filed on Apr. 13, 2006.

(51) Int. Cl. B60T 11/00

(52) U.S. Cl. 188/344

(57) ABSTRACT

A brake system comprises a brake lever that operates an integrated brake assembly that is housed within a portion of the frame of a bicycle. Operation of the brake system can employ a master cylinder that is actuated by the brake lever either directly or by cable. Actuation of the master cylinder causes one or more corresponding slave cylinders to actuate. The slave cylinders are operatively coupled with the master cylinder via a hydraulic line. Actuation of the one or more slave cylinders causes a brake pad that is connected to the slave cylinder to come into contact with the rim of the bicycle.

### RELATED APPLICATION

The present application claims priority to co-pending U.S. provisional patent application Ser. No. 60/744,834 filed on Apr. 13, 2006 which is incorporated herein by reference in its entirety.

### BACKGROUND

1. Field of the Invention

The present invention is related to bicycles and braking systems for bicycles.

2. Related Art

Bicycles must have brakes to stop quickly and safely. Conventional bicycle brakes bolt onto frame components such as the fork, seat stay, or chain stay at one or more places. When actuated, the brakes apply a force to the wheel stopping it gradually. The force applied at the brake lever is conveyed through the components of the brake including the cables and levers and attachment points on the frame components. These components and attachment points must be strong enough to transmit this force onto the wheel. Additionally, because bicycles are typically human powered and humans have limited power output any reduction in weight of the bicycle lessens the burden the rider must overcome when pedaling the bicycle to produce locomotion.

Conventional brake designs approach the aerodynamic problem by minimizing the frontal area of the brake caliper itself, and making the brake caliper as aerodynamic as possible. In many cases the design is made to stay within the silhouette of the bicycle fork and/or head tube. While this is an aerodynamic improvement over previous designs, these conventional brake designs have much room for improvement. Very often these designs must compromise braking power to improve aerodynamics.

Conventional brake designs are actuated by a cable (wire) or hydraulic means. Traditional designs leave this wire or hydraulic line exposed to the airflow. The attachment of the cable or line to the brake lever and its attachment to the handle bars leave a round tubular section of cable or line exposed to the airflow. This disrupts the airflow creating a significant wake before the air even has a chance to contact the bicycle frame itself. In the instance of aerodynamic bicycle frames, much of the benefit of the aerodynamic frame is reduced because the airflow is turbulent before contacting the frame, minimizing the benefits provided by the frame design. In the instance of the rear brake, the brake cable or line increases the size of the wake created by rider and/or bicycle. Although internal brake cable or line routing has been used on bicycles for some time, the cables or lines still must exit the frame or fork to attach to the brake. Therefore, what is needed is a system and method that overcomes these significant problems found in the conventional systems as described above.

### SUMMARY

A portion of a bicycle frame (e.g., fork, seat stay, or chain stay) has a brake assembly housed within it. The brake assembly is an integrated unit inside the portion of the frame that can be operated by a hydraulic mechanism or by a lever and cable assembly or combination of a lever and cable assembly and a hydraulic mechanism. The integration of the brake components into a portion of the bicycle frame eliminates external cable or house routing and also eliminates external attachment points and associated brake components. This provides for a brake system that is both lighter in weight and more aerodynamic than conventional systems. The integrated brake design allows for the control cable or line to be routed through the handle bars and head tube and into the fork (for the front brake) or into the frame (for the rear brake). The stem and handlebar are drilled appropriately to accept internal routing of cable or line. In the case of the current state of the art brake levers, the cable would need to exit the interior of the handlebar to attach to the shift lever.

The integrated brake design does not require any external cable or line that would reduce the aerodynamic efficiency of the bicycle. As noted above the cable or line could exit the handlebars before attaching to the brake levers, if using the current state of the art. The cable or line routed externally to the handlebars may not reduce the aerodynamic efficiency of the bicycle significantly as it may still be routed under the handle bar tape. Lever designs could be adapted to accept a totally internal routing. Additionally, the integration of the brake into the fork or stay allows for significantly more flexibility in the aerodynamic design of the fork or stay. For example, the shape of the fork body itself will not be constrained by the necessity to have an attachment point for a brake. Because the front fork is one of the first parts of a forward moving bicycle to encounter air resistance it has a significant influence on the airflow around the bicycle. The rear brake (whether mounted to the seat stay or the chain stays of the bicycle) is one of the last portions of a bicycle to pass through a given airspace, and its influence on the size of the aerodynamic wake is significant. The size of this wake is a key contributor to aerodynamic drag (or resistance). The integrated brake design reduces this wake and correspondingly decreases the aerodynamic drag the rider must overcome.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a view diagram illustrating an example frame integrated hydraulic bicycle braking system according to an embodiment of the present invention;

FIG. 2 is a view diagram illustrating an example integrated brake assembly with hydraulic slave cylinders according to an embodiment of the present invention;

FIG. 3 is a view diagram illustrating an example integrated brake assembly inside the bicycle frame components according to an embodiment of the present invention;

FIG. 4 is a view diagram illustrating an example frame integrated hydraulic bicycle braking system according to an embodiment of the present invention; and

FIG. 5 is a view diagram illustrating an example bicycle according to an embodiment of the present invention.

### DETAILED DESCRIPTION

Certain embodiments as disclosed herein provide for an integrated brake assembly that is housed within a portion of the frame of a bicycle and connected to the brake lever through internally routed cables or lines. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

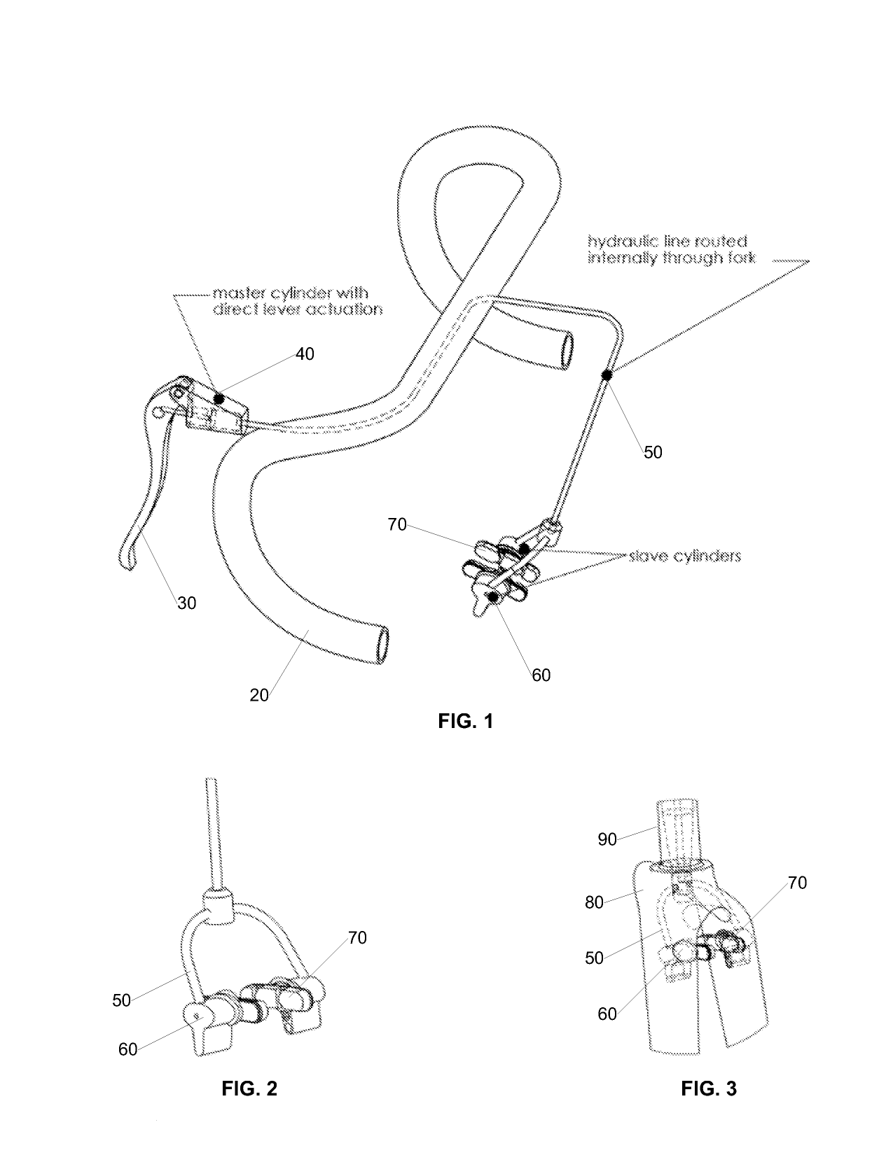

FIG. 1 is a view diagram illustrating an example frame integrated hydraulic bicycle braking system according to an embodiment of the present invention. In the illustrated embodiment, the braking system comprises a brake lever 30 that is coupled with a master cylinder 40. The brake lever 30 is attached to the handlebars 20 and a hydraulic line 50 connects the master cylinder 40 to at least one slave cylinder 60. One or more brake pads 70 are connected to each slave cylinder 60 and an extending arm or fixed post may be disposed between the slave cylinder 60 and the brake pad 70 for appropriate distance spacing. Together the slave cylinders 60 and the brake pads 70 and any connecting arm or post (not shown) comprise the brake assembly.

The slave cylinder is made up of cylinder, piston, return spring seals, and associated ports for the addition or removal of hydraulic fluid from the system. The brake pads are connected to the slave piston by various means. The pads can be an integrated extension of the cylinder, or attach to it via fasteners, a pad retaining channel or spring clips, whatever is appropriate for the application. The brake pad moves with the piston toward the rim during braking and away as the brake lever is released.

In operation, when the brake lever 30 is engaged by an operator, the master cylinder 40 is activated and displaces hydraulic fluid in the master cylinder through the hydraulic line 50 to the slave cylinders 60. The additional fluid in the slave cylinder extends the slave piston which causes the brake pads to come into contact with the rim of a bicycle wheel and thereby slow the bicycle.

Advantageously, as can be seen in the illustrated embodiment, the hydraulic line 50 is routed internally to the frame of the bicycle. Specifically, the line 50 is shown traveling internally within the handlebars 20. Although the other frame components are not shown in the diagram, the line 50 continues to travel internally or externally within or around the frame components including the stem, and handlebars. Once reaching the steerer tube of the bicycle (the tube of the fork that the fork pivots on) the hydraulic line or cable must travel inside the fork so as to avoid tangling with the bicycle steering bearings. In the case of brakes at the rear of the bicycle frame such as the seat stay or chain stay, the hydraulic line 50 may exit the frame momentarily to allow for the steering mechanism to pivot. Additionally, the brake assembly, which includes the slave cylinders and the brake pads are disposed internally within the fork (not shown).

As is understood in the art, each of the cylinders may be an assembly of cylinder, piston seals etc. such that when the piston is activated in the master cylinder, it displaces fluid that travels through the line to the slave cylinder assembly. Because the fluid does not compress, the displaced fluid travels through the line and displaces the slave piston which the brake pads are attached to. In the case of hydraulic brakes the brake assembly can be a combination of opposing slave cylinders that are connected by the structure of the fork. Accordingly, as used herein the term cylinder is considered to include the related cylinder, piston assembly, and associated seals, bleeder ports, etc. that allow the cylinder to perform its intended function.

FIG. 2 is a view diagram illustrating an example integrated brake assembly with hydraulic slave cylinders according to an embodiment of the present invention. In the illustrated embodiment, the hydraulic line 50 and its connection to the slave cylinders 60 is shown. FIG. 2 shows the cylinders connected in a parallel hydraulic circuit. It would also be acceptable to have the slave cylinders connected in series, as the fluid pressure will be equal throughout the system. Also shown are the brake pads 70 that are connected to the slave cylinders 60 via the piston. Actuation of the slave cylinders 60 causes the pistons to extend toward the bicycle rim causing the brake pads 70 to contact the rim of a bicycle wheel. In alternative embodiments the pads can be attached to a member or lever that is actuated directly via cable pivoting on a fulcrum internal to the frame component. The brake pad can also be attached to a cable actuated cam mechanism that extends the pads toward the rim via mechanical means instead of hydraulic.

FIG. 3 is a view diagram illustrating an example integrated brake assembly inside the bicycle frame component according to an embodiment of the present invention. In the illustrated embodiment, the hydraulic line 50 is routed through the internal cavities of the bicycle frame component, in this case the bicycle fork. Specifically, the line 50 is routed from master cylinder at the brake lever, through the inside or along the outside of the handlebars and stem (not shown) and inside the steerer tube 90 and inside the fork 80 to the slave cylinder/piston assembly 60 to which the brake pads 70 are attached.

In alternative embodiments, the braking means can be a combination of master and slave cylinders as illustrated in FIGS. 1-3. The braking means can also include a cable actuated master cylinder that is disposed somewhere within the frame components between the brake lever and the slave cylinder/piston assembly(s). For example, the master cylinder may be disposed inside the steerer tube of the fork and actuated by a cable that is connected to the brake lever. In such an embodiment the hydraulic line would still extend from the master cylinder to the one or more slave cylinders but the master cylinder would be actuated remotely via cable and lever combination rather than directly by the brake lever itself. In yet another embodiment, the braking means can be implemented as a cable system that routs a cable internally from the brake lever to the brake arms to cause the brake pads to come into contact with the rim of a wheel when the brake lever is engaged.

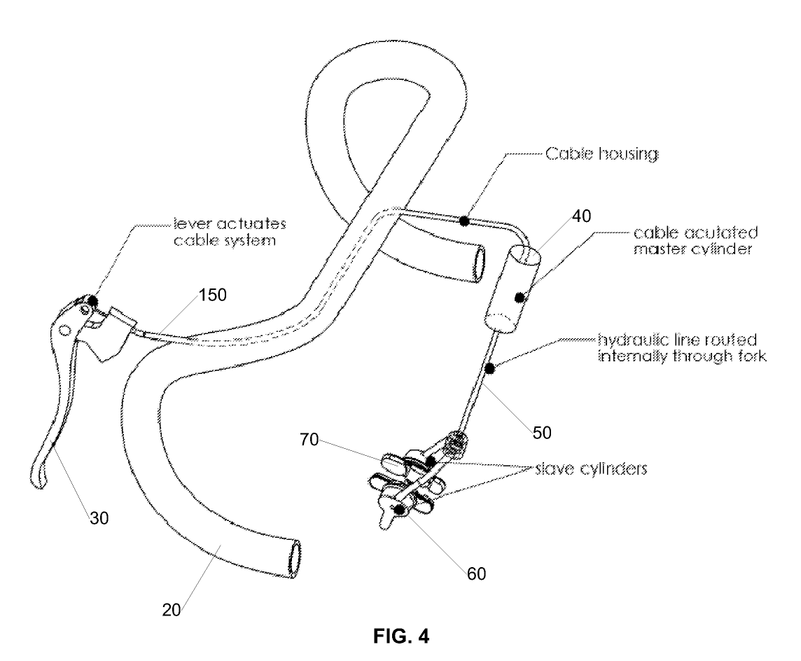

FIG. 4 is a view diagram illustrating an example frame integrated hydraulic bicycle braking system according to an embodiment of the present invention. In the illustrated embodiment, the master cylinder 40 is disposed in a location remote to the brake lever 30. The remote location can be in the steerer tube of the fork (the fork and steerer tube are omitted from the figure for clarity) or in another remote location that is connected to the brake lever by a cable 150 that is configured to actuate the master cylinder 40 when an operator engages the brake lever.

Advantageously, remote actuation of the master cylinder by a cable means allows the master cylinder to be located inside the fork or frame and actuated by conventional cable type brake levers. Another advantage of the remotely located master cylinder is that it converts the brake system from cable to hydraulic at a location remote to the brake lever, for example inside the fork or inside another component of the frame. Accordingly, current state of the art cable actuated brake levers with integrated shift controls can be used with the remotely actuated master cylinder embodiment.

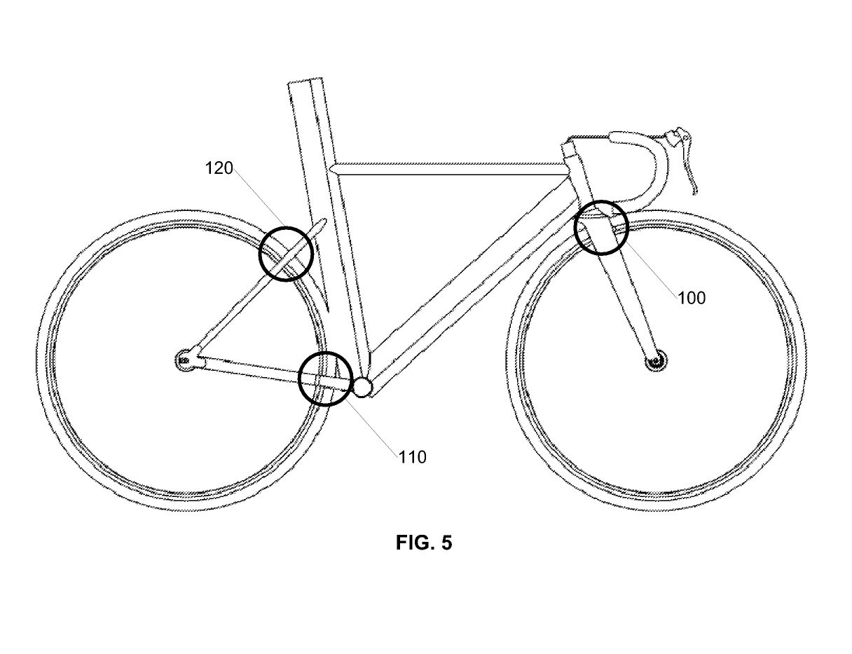

FIG. 5 is a view diagram illustrating an example bicycle according to an embodiment of the present invention. In the illustrated embodiment, example locations for implementing the present invention are shown. For example, location 100 is a location inside the fork where the brake system may be integrated, location 110 is a location inside the chain stay where the brake system may be integrated, and location 120 is a location inside the seat stay where the brake system may be integrated. It is generally noted that suitable locations for this type of mechanism is where the frame is in close proximity to the rim braking surface of either wheel as shown.

It is important to note that the brake assembly may be disposed within a cavity of the frame at the various locations 100, 110, and 120 or the brake assembly may be an integral part of the frame component that is not removable. For example, the caliper structure of the brake assembly contributes to the structure of the fork and vice versa. Such an integrated embodiment advantageously allows a more efficient use of structural material enabling a reduction of the overall weight of the bicycle. An advantage of an embodiment where the brake assembly is disposed in a cavity of the frame is that such an embodiment may be provided at reduced cost.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A bicycle brake system comprising:
a brake lever configured to be engaged by an operator;
a master cylinder coupled with the brake lever and configured to be activated when the brake lever is engaged by an operator;
at least one slave cylinder communicatively coupled with the master cylinder through an internal frame component cavity, the slave cylinder configured to be activated in response to activation of the master cylinder;
at least one brake pad coupled with the slave cylinder, wherein the slave cylinder is substantially disposed inside a frame member and the brake pad is substantially dispose outside the frame member and the brake pad is configured to engage the rim of a wheel in response to activation of the slave cylinder.

2. The bicycle brake system of claim 1, wherein the master cylinder is coupled with the brake lever via a brake cable for enabling remote actuation of the master cylinder.

3. The bicycle brake system of claim 1, wherein the master cylinder is coupled with the at least one slave cylinder via a hydraulic line.

4. The bicycle brake system of claim 3, wherein the hydraulic line is configured to travel through the steerer tube and fork of the bicycle.

5. The bicycle brake system of claim 1, wherein the at least one brake assembly is substantially disposed in an internal cavity of a fork.

6. The bicycle brake system of claim 1, wherein the at least one brake assembly is substantially disposed in an internal cavity of a chain stay.

7. The bicycle brake system of claim 1, wherein the at least one brake assembly is substantially disposed in an internal cavity of a seat stay.

8. A bicycle brake system comprising:
a brake lever configured to be engaged by an operator;
braking means for transmitting a force from the brake lever to a brake assembly in response to engagement of the brake lever, wherein the braking means is disposed in an internal cavity of one or more frame components;
at least one brake assembly comprising a brake pad, the brake assembly substantially disposed in an internal cavity of a frame component, wherein the brake pad is configured to engage the rim of a wheel in response to the brake assembly receiving the transmitted force from the braking means.

9. The bicycle brake system of claim 8, wherein the braking means comprises a master cylinder coupled with the brake lever and one or more slave cylinders coupled with the at least one brake assembly.

10. The bicycle brake system of claim 9, wherein the master cylinder is coupled with the one or more slave cylinders via a hydraulic line.

11. The bicycle brake system of claim 8, wherein the braking means comprises a brake cable coupled with the brake lever and a master cylinder and one or more slave cylinders coupled with the at least one brake assembly.

12. The bicycle brake system of claim 11, wherein the master cylinder is coupled with the one or more slave cylinders via a hydraulic line.

13. The bicycle brake system of claim 8, wherein the braking means comprises a brake cable coupled with the brake lever and the at least one brake assembly.

14. The bicycle brake system of claim 8, wherein the at least one brake assembly is substantially disposed in an internal cavity of a fork.

15. The bicycle brake system of claim 8, wherein the at least one brake assembly is substantially disposed in an internal cavity of a chain stay.

16. The bicycle brake system of claim 8, wherein the at least one brake assembly is substantially disposed in an internal cavity of a seat stay.

17. The bicycle brake system of claim 8, wherein the at least one brake assembly is an integral part of a fork.

18. The bicycle brake system of claim 8, wherein the at least one brake assembly is an integral part of a chain stay.

19. The bicycle brake system of claim 8, wherein the at least one brake assembly is an integral part of a seat stay.
